(19) United States
(12) Patent Application Publication
(10) Pub. No.: US 2011/0055134 A1
(43) Pub. Date: Mar. 3, 2011

(54) DYNAMIC RESOURCE-BASED WEB SERVICE EVALUATION

(76) Inventors: Martin DVORAK, Prague (CZ); Ulrich Feyer, Aidlingen (DE); Jan Odstrcil, Prague (CZ)

(21) Appl. No.: 12/546,735

(22) Filed: Aug. 25, 2009

(51) Int. Cl. G06N 5/02; G06F 15/173; G06F 11/36; G06F 15/16; G06F 11/00

(52) U.S. Cl. 706/47; 709/226; 714/38; 714/E11.02

(57) ABSTRACT

Systems and other embodiments associated with a resource-based web service are described. One example system comprises exploration logic configured to dynamically determine a configuration for a resource-based web service. The example system also comprises evaluation logic configured to test the configuration according to a testing policy. A result is acquired by testing the configuration according to the testing policy. Additionally, the system comprises control logic configured to control a user interface to report the result.

### BACKGROUND

A web service may be a software system that supports machine-to-machine interaction. The web service may be constructed with different architecture styles. In one example, the web service may be constructed with a Representational State Transfer (REST) architecture style. An REST web service may be accessible by machines engaged in machine-to-machine interaction. These machines and users that use these machines may become reliant upon the REST web service.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of a system that manages a configuration associated with a resource-based web service.

FIG. 2 illustrates one embodiment of a system to govern and manage a resource-based web service.

FIG. 3 illustrates one embodiment of a method for testing a resource-based web service.

FIG. 4 illustrates one embodiment of a method for testing a resource-based web service.

FIG. 5 illustrates one embodiment of a computing environment in which example systems and methods of resource-based web services, and equivalents, may operate.

### DETAILED DESCRIPTION

Systems and methods associated with resource-based web service evaluation are described. Web services may be configured in different architectures. In one embodiment, web services are configured with a Representational State Transfer (REST) architecture. The REST web services may be evaluated to determine whether the REST web services are functioning properly.

The REST web service may be tested as part of the evaluation. A REST web service focuses on resources and may associate with a dynamic Uniform Resource Locator (URL) space. The dynamic URL space may experience changes during runtime. In response to these changes, a user may desire to test the URL space to determine if certain aspects of the web service are operating properly. In one embodiment, the URL space may be traversed and tested by a URL space explorer. The URL space explorer may identify resource representations of the URL space and pass those resource representations to a test policy enforcer. The test policy enforcer verifies the resource representations to determine if the REST web service complies with policies. A policy report may be generated by a reporting unit in response to a test policy enforcer operation. The policy report alerts the user to a non-compliant REST web service aspect or notifies the user that the REST web service is compliant. Thus, the user can quickly test the REST web service by using the URL space explorer and test policy enforcer.

The following includes definitions of selected terms employed herein. The definitions include various examples and/or forms of components that fall within the scope of a term and that may be used for implementation. The examples are not intended to be limiting. Both singular and plural forms of terms may be used within the definitions.

References to “one embodiment” “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

The following are definitions for acronyms used herein: ASIC: application specific integrated circuit; CD: compact disk; CD-R: CD recordable; CD-RW: CD rewriteable; DVD: digital versatile disk and/or digital video disk; RAM: random access memory; ROM: read only memory.

“Computer-readable medium”, as used herein, refers to a storage medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other tangible media from which a computer, a processor or other electronic device can read.

“Logic”, as used herein, includes but is not limited to hardware, firmware, instructions stored or in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived Lo be a sequence of operations that produce a result. The operations include physical manipulations of physical quantities. Usually, though not necessarily, the physical quantities take the form of electrical or magnetic signals capable of being stored, transferred, combined, compared, and otherwise manipulated in a logic, and so on. The physical manipulations transform electronic components and/or data from one state to another.

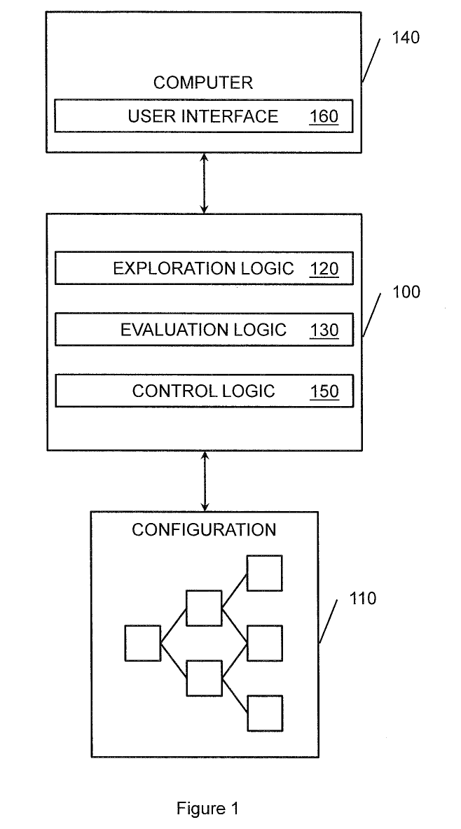

FIG. 1 illustrates one embodiment of a system 100 that manages a configuration 110 associated with a resource-based web service. The configuration 110 may be a resource arrangement. An example resource arrangement may be a declarative Application Programming Interface. In one embodiment, the resource arrangement is or complies with a representational state transfer (REST) architectural style. The resource arrangement may include resources that interrelate. The resource-based web service may be dynamic and thus relationships among the resources may change. In one example, a user may add functionality to the resource-based web service. This functionality may cause relationships between resources to change. A change in relationships may cause a policy violation in the configuration 110. In one embodiment, the configuration 110 is a dynamic set of constraints, filters, and/or rules. The system 100 may analyze the configuration 110 to determine if a policy violation exists.

The system 100 may include exploration logic 120. The exploration logic 120 is configured to determine the configuration 110 for the resource-based web service. The exploration logic 120 may search a Uniform Resource Locator (URL) space. The URL space may be a dynamic URL set. The URL space may be associated with the resource-based web service. In one embodiment, a user makes a request for the exploration logic 120 to search the URL space. A search may occur periodically and/or automatically. The search may produce search results. Evaluation logic 130 may process the search results.

The system 100 may include evaluation logic 130. The evaluation logic 130 may test the configuration 110 according to a testing policy. A result may be acquired by testing the configuration 110 according to the testing policy. In one embodiment, the testing policy is user designable. In one example, a user may configure the testing policy from a computer 140. In another example, the user may configure which resource-based web service aspects to test. In addition, the user may initiate the test from the computer 140. The user may also initiate exploration logic operation from the computer 140. With one example testing policy, the evaluation logic 130 may test at least one functional aspect of the configuration 110. The evaluation logic 130 may also test at least one non-functional aspect of the configuration 110. The evaluation logic 130 may test the configuration 110 automatically and/or incrementally according to the testing policy. The testing may facilitate determining if the configuration 110 includes a policy violation.

The system 100 may also include control logic 150. The control logic 150 may control a user interface 160 to report the result from testing the configuration 110. The configuration 110 may include collections, member entries, and so on. In one example, the control logic 150 may cause a report to be presented on a display associated with the computer 140. The report may notify a user of policy compliance associated with the resource-based web service. Thus, the system 100 may be used to manage the configuration 110 associated with a resource-based web service.

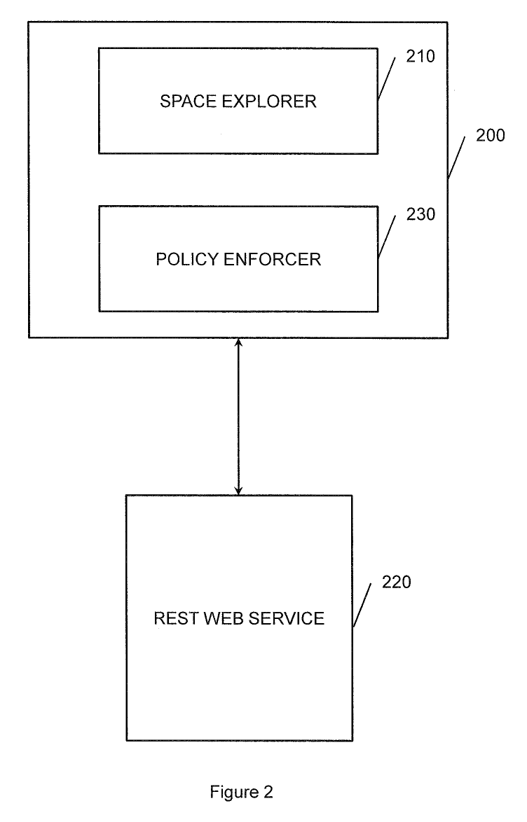

FIG. 2 illustrates one embodiment of a system 200 that governs and manages a resource-based web service. The system 200 may include a space explorer 210. The space explorer 210 dynamically discovers a URL space associated with a REST web service 220. Dynamic discovery may occur when a change takes place in the URL space. Changes may occur, for example, when a new resource is added, when a resource is deleted, when a new representation is added, and so on. A resource may be a collection, member entity, and so on. The space explorer 210 may be regulated by a rule set. In one embodiment, the rule set defines at least one aspect of the REST web service 220 to test.

The system 200 includes a policy enforcer 230. The policy enforcer 230 controls a device as a function of testing the URL space. The policy enforcer 230 may also test the URL space. In one embodiment, a URL space test occurs automatically and/or incrementally. In one embodiment, the URL space test analyzes a non-functional aspect of the REST web service 220 and/or a functional aspect of the REST web service 220. With an example non-functional aspect, the URL space test may determine if the REST web service 220 is structured in an appropriate manner. With an example functional aspect, the URL space test may determine if a calculator associated with the REST web service 220 correctly evaluates an expression. The URL space test may be regulated by a test assertion set. The test assertion set may define how to test the URL space. A result from the URL space test may be used by the policy enforcer 230 to control the device.

In one embodiment, the REST web service 220 is configured with a REST architecture style. The REST web service 220 may communicate with other entities by using an Atom Publishing Protocol (APP). The REST web service 220 may include an APP Service Document that functions as an entry point of service. The APP Service Document references selective service collections and provides information about the REST web service 220. A service client that is integrated with the space explorer 210 may follow the referenced collections and retrieve an Atom representation associated with a referenced collection. The Atom representation may include alternative representations, links to collection member entries, links to related collections, a query interface description, links to edit URLs, links to prototype objects, associated schemas, categories, and so on. The Atom representation may be used to test the REST web service 220.

The space explorer 210 may traverse and test the URL space associated with the REST web service 220. Traversing and/or testing may be done by using auto discovery. The space explorer 210 may pass resource representations discovered to the policy enforcer 230. The policy enforcer 230 may test operations. Operations may include create, update, and delete operations. Performed test operations may be based on prototype objects. In addition, update and deletion test operations may operate on existing resources. Once test operations are ready for use, the operations transfer to the policy enforcer 230.

The policy enforcer 230 tests resource representations. An example resource representation is a retrieved Atom representation. In one embodiment, the policy enforcer 230 uses individual policies for specific representation types. Example types with individual policies include Atom, Extensible Markup Language, and so on. A policy may be a set of test assertions that may be added or removed according to testing requirements. A test assertion may be a configurable aspect of the REST web service 220. Example test assertions may test schema validity, test existence and value integrity, test valid taxonomy categorizations, test link existence, test constraints on a representation's format, and so on. In addition, a test assertion may include an associated validator. The validator may be configured with various parameters. The validator may be executable code that runs a test. Thus, REST a web service may be tested.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks.

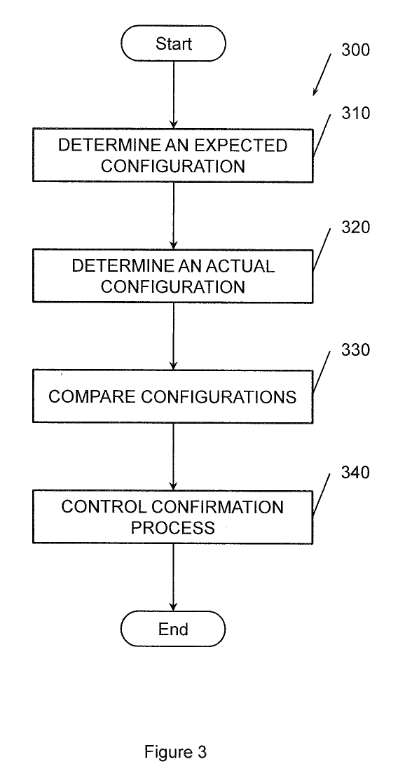

FIG. 3 illustrates one embodiment of a method 300 for testing a resource-based web service. The resource-based web service may be dynamic and experience changes after implementation. With one example change, features may be added and removed from the resource-based web service. Based on the change, a certain implementation for a configuration may be expected. However, an expected configuration implementation may be different from an actual configuration implementation. Therefore, the method 300 may check if an anticipated configuration is the same as how the configuration actually implements.

The method 300 begins, at 310, by determining an expected configuration of a resource-based web service. An example resource-based web service is a REST web service. In one embodiment, a change in the resource-based web service is observed. A determination is made on how the observed change is expected to modify the resource-based web service. In one embodiment, a user inputs the expected change and the determination is made by evaluating the user input. Determining the expected configuration may include collecting the expected configuration from a user interface.

A determination is made, at 320, for an actual configuration of the resource-based web service. Various software tests can be run on the resource-based web service to determine how the resource-based web service is configured. Making the determination may include testing the resource-based web service according to a testing policy.

The actual configuration is compared with the expected configuration, at 330, to produce a result. The result may be a data sheet showing a product from the comparison, a summary detailing where the actual configuration and expected configuration differ, and so on. A confirmation process may be controlled, at 340, as a function of the result. The confirmation process enables a user to determine if a web service functions as expected.

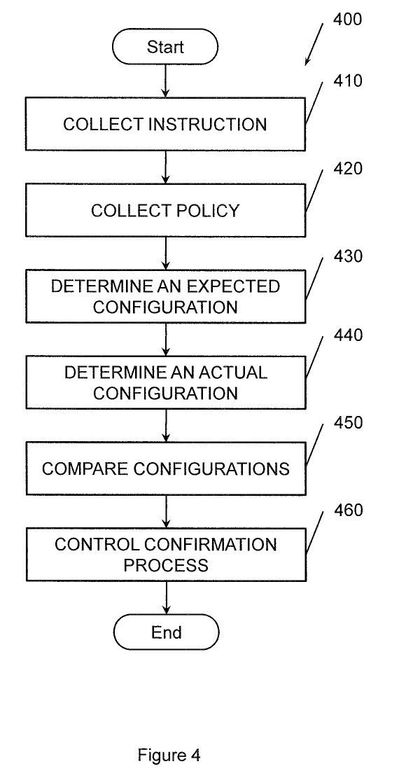

FIG. 4 illustrates one embodiment of a method 400 for testing a resource-based web service. An example resource-based web service is a REST web service. Similar to the method 300 of FIG. 3, a resource-based web service may experience a change. The change may cause an alteration in a configuration different from what is expected. Thus, a test may occur to determine if a difference exists.

An instruction for testing the resource-based web service may be collected, at 410, from a user interface. In one example, a network administrator makes changes to the resource-based web service and requests that the resource-based web service be evaluated. Thus, the instruction designates the resource-based web service upon which determinations are made. In addition, a policy may be collected at 420. The policy may be used in determining an expected configuration and/or determining an actual configuration for the resource-based web service. The policy may be included with the instruction, a request may be made to the network administrator after the instruction is collected on what policy should be implemented, a previously saved policy may be collected, and so on.

The policy may be used to determine, at 430, the expected configuration of the resource-based web service. The expected configuration may comprise an anticipated arrangement for the resource-based web service. In one embodiment, the network administrator enters an anticipated configuration and the determination is made by evaluating the entered anticipated configuration. The anticipated configuration may be a user-produced configuration. In another embodiment, changes are analyzed and a determination is made on how the configuration is expected to be arranged based on the changes.

An actual configuration of the resource-based web service may be determined at 440. The actual configuration may comprise a verified arrangement for the resource-based web service. In one embodiment, the resource-based web service is a REST web service. In another embodiment, the expected configuration and actual configuration are an arrangement of interrelated resources in a representational state transfer architectural style. A comparison of the actual configuration with the expected configuration occurs, at 450, to produce a result. A confirmation process is controlled, at 460, as a function of the result. In one embodiment, the confirmation process is an operation to determine if a configuration is arranged as expected. Therefore, the method 400 may be used to test a resource-based web service configuration.

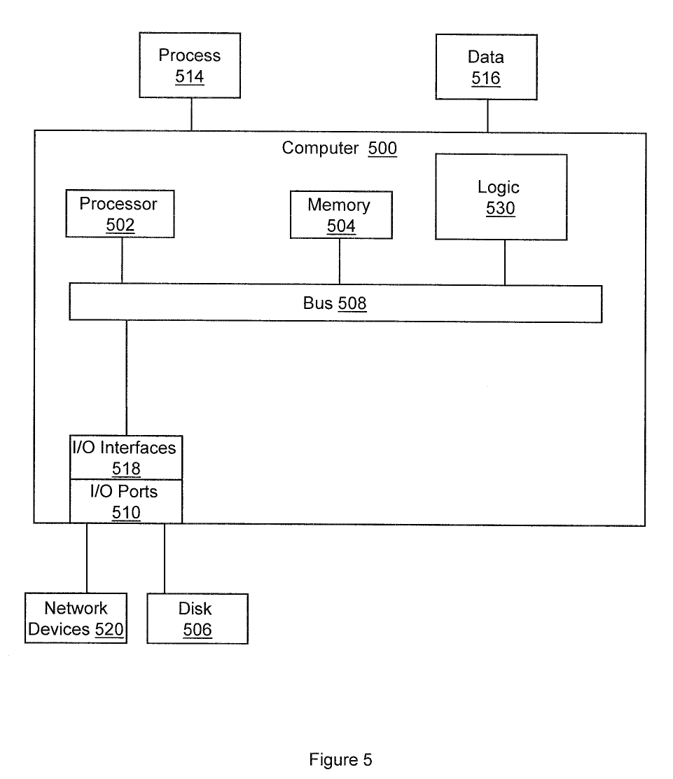

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, the computer 500 may include a logic 530 configured to adaptively test an REST web service. In different examples, the logic 530 may be implemented in hardware, software, firmware, and/or combinations thereof. While the logic 530 is illustrated as a hardware component attached to the bus 508, it is to be appreciated that in one example, the logic 530 could be implemented in the processor 502.

Thus, logic 530 may function as the space explorer 210 and/or the policy enforcer 230 (see FIG. 2). The logic 530 may also function as at least one logic discussed in FIG. 1. The logic 530 may be implemented, for example, as an ASIC. The logic 530 may also be implemented as computer executable instructions that are presented to computer 500 as data 516 that are temporarily stored in memory 504 and then executed by processor 502.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM or PROM. Volatile memory may include, for example, RAM, SRAM, and DRAM.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, and a memory stick. Furthermore, the disk 506 may be a CD-ROM drive, a CD-R drive, a CD-RW drive, a DVD ROM drive, a Blu-Ray drive, and an HD-DVD drive. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, displays, the disk 506, and the network devices 520. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A system, comprising:
exploration logic configured to dynamically determine a configuration for a resource-based web service;
evaluation logic configured to test the configuration according to a testing policy, where a result is acquired by testing the configuration according to the testing policy; and
control logic configured to control a user interface to report the result.

2. The system of claim 1, where the exploration logic is configured to dynamically determine the configuration by searching a Uniform Resource Locator space associated with the resource-based web service.

3. The system of claim 1, where the resource-based web service is a representational state transfer web service.

4. The system of claim 1, where the configuration is an arrangement of resources in a representational state transfer architectural style and where resources of the arrangement interrelate.

5. The system of claim 1, where the evaluation logic is configured to automatically test the configuration according to the testing policy.

6. The system of claim 1, where the evaluation logic is configured to incrementally test the configuration according to the testing policy.

7. The system of claim 1, where the testing policy is user designable.

8. The system of claim 1, where the evaluation logic is configured to test at least one functional aspect of the configuration and at least one non-functional aspect of the configuration.

9. A method, comprising:
determining an expected configuration of a representational state transfer (REST) web service;
determining an actual configuration of the REST web service;
comparing the actual configuration with the expected configuration to produce a result; and
controlling a confirmation process as a function of the result.

10. The method of claim 9, where the expected configuration comprises an anticipated arrangement for the REST web service.

11. The method of claim 9, where the actual configuration comprises a verified arrangement for the REST web service.

12. The method of claim 9, where the expected configuration is an arrangement of interrelated resources in a REST architectural style.

13. The method of claim 9, where the actual configuration is an arrangement of interrelated resources in a REST architectural style.

14. The method of claim 9, comprising:
collecting an instruction from a user interface, where the instruction designates the REST web service.

15. The method of claim 9, comprising:
collecting a policy, where the policy is used in determining the expected configuration and determining the actual configuration.

16. The method of claim 9, where determining an expected configuration of the REST web service comprises evaluating a user-produced configuration.

17. The method of claim 9, where determining an actual configuration of the REST web service comprises testing the REST web service according to a testing policy.

18. A system, comprising:
means for dynamically discovering a Uniform Resource Locator space associated with a representational state transfer web service; and
means for controlling a device as a function of testing the Uniform Resource Locator space, where testing is automatic and incremental.

19. The system of claim 18, where the means for dynamically discovering is regulated by a rule set and where the rule set defines at least one aspect of the web service to test.

20. The system of claim 18, comprising:
means for testing the Uniform Resource Locator space, where the means for testing the Uniform Resource Locator space is regulated by a test assertion set, where the test assertion set defines how to test the Uniform Resource Locator space, and where the means for controlling uses a result from the means for testing to control the device.
